(19) United States
(12) Patent Application Publication
(10) Pub. No.: US 2022/0170959 A1
(43) Pub. Date: Jun. 2, 2022

(54) Tap Timer and a Method and System for Detecting Detachment of a Tap Timer from a Faucet

(71) Applicant: LinkTap Pty. Ltd., Belconnen, Australian Capital Territory (AU)

(72) Inventor: Qi Wang, Belconnen (AU)

(21) Appl. No.: 17/437,127

(22) PCT Filed: Jul. 24, 2019
(86) PCT No.: PCT/AU2019/050776

§ 371 Date: Sep. 8, 2021

(30) Foreign Application Priority Data
Mar. 15, 2019 (AU) 2019100274

(51) Int. Cl. G01P 15/18

(52) U.S. Cl. CPC G01P 15/18; A01G 25/165

(57) ABSTRACT

A tap timer and a method and system for detecting detachment of a tap timer from a faucet are provided. The method comprises measuring a first acceleration vector of the tap timer; measuring periodically a second acceleration vector of the tap timer after measuring the first acceleration vector; calculating a value based on the first acceleration vector and the second acceleration vector; and comparing the value with a predetermined value threshold to determine whether the tap timer has detached from the faucet.

### CROSS-REFERENCE TO RELATED APPLICATIONS

This application is a 371 national phase application and claims priority to PCT Patent Application PCT/AU2019/050776, filed Jul. 24, 2019, which claims priority to Australian Patent Application 2019100274, filed Mar. 15, 2019, the content of each of which is hereby incorporated by reference.

### TECHNICAL FIELD

The present disclosure relates to a tap timer. The present disclosure also relates to a method of, and a computing system for, detecting detachment of a tap timer from a faucet.

### BACKGROUND

Tap timers are known and are typically used in conjunction with irrigation sprinklers to form an automated watering system, capable of administering water at predetermined time intervals. More and more users have started to use tap timers as a means to conveniently water plants in their homes automatically. Tap timers typically include an inlet that is threadingly attached to a faucet, an outlet attached to the irrigation sprinkler, a conduit that extends between the inlet and outlet for allowing water flow therethrough, a solenoid valve for controlling water flow through the conduit, and an automated controller that actuates the solenoid valve to permit or stop the flow of water through the conduit.

A problem with known tap timers is that they can detach from the faucet after prolonged periods of use. This may be a result of the inlet of the tap timer deteriorating due to exposure to external environmental factors, such as sunlight and temperature variations, for example. Further, the internal thread of the inlet may wear out over time due to vibrations and movement between the tap timer and the faucet caused by water flow, thus loosening the attachment between the inlet and the faucet. Further still, high water pressure through the faucet may cause the tap timer to suddenly burst off the faucet. The detachment of tap timers from faucets often occurs without any prior indications, resulting in water being discharged from the faucet, which can lead to flooding and damage to property.

The detachment of tap timers from faucets is a concern for many users. One disadvantage is that current watering systems do not effectively or efficiently detect detachment of a tap timer from a faucet. Another disadvantage is that when a tap timer does detach from a faucet, users are often unaware that detachment has occurred, which leads to disastrous consequences that is often too late to remedy.

### SUMMARY

In an aspect of the present disclosure, there is provided a method of detecting detachment of a tap timer from a faucet, the method comprising:

measuring a first acceleration vector of the tap timer; measuring periodically a second acceleration vector of the tap timer after measuring the first acceleration vector;

calculating a value based on the first acceleration vector and the second acceleration vector; and comparing the value with a predetermined value threshold to determine whether the tap timer has detached from the faucet.

The method may further comprise transmitting a notification signal to a network device in response to the determination that the tap timer has detached from the faucet.

The value calculated may be a vector distance between the first acceleration vector and the second acceleration vector.

The predetermined value threshold may be about 0.68 m/s².

The value calculated may be an inclination angle derived from the first acceleration vector and the second acceleration vector.

The predetermined value threshold may be between 10 to 30 degrees.

The second acceleration vector may be measured periodically every 15 seconds.

The method may further comprise, prior to calculating the value, validating the second acceleration vector based on a predetermined validation threshold.

The method may further comprise, prior to calculating the value, filtering the second acceleration vector.

In another aspect of the present disclosure, there is provided a tap timer, comprising:

an accelerometer; a memory or storage device configured to store processor-executable instructions;

and a processor operatively connected to the memory or storage device and the accelerometer, the processor configured to execute the stored processor-executable instructions, wherein executing the stored processor-executable instructions causes the processor to:

receive, from the accelerometer, first acceleration data indicative of a first acceleration vector of the tap timer;

receive periodically, from the accelerometer, second acceleration data indicative of a second acceleration vector of the tap timer after receiving the first vector data;

calculate a value based on the first acceleration data and the second acceleration data; and compare the value with a predetermined value threshold to determine whether the tap timer has detached from the faucet.

The tap timer may further comprise a wireless communication device operatively connected to the processor, and executing the stored processor-executable instructions may further cause the processor to:

transmit a notification signal, by the wireless communication device, to a network device in response to the determination that the tap timer has detached from the faucet.

The value calculated may be a vector distance between the first acceleration vector and the second acceleration vector.

The predetermined value threshold may be about 0.68 m/s².

The value calculated may be an inclination angle derived from the first acceleration vector and the second acceleration vector.

The predetermined value threshold may be between 10 to 30 degrees.

The processor may receive periodically, from the accelerometer, the second acceleration data every 15 seconds.

Executing the stored processor-executable instructions may further cause the processor to:

prior to calculating the value, validate the second acceleration data based on a predetermined validation threshold.

Executing the stored processor-executable instructions may further cause the processor to:

prior to calculating the value, filter the second acceleration data.

The accelerometer may be a three-axis accelerometer.

In a further aspect of the present disclosure, there is provided a computing system for detecting detachment of a tap timer from a faucet, the tap timer having an accelerometer, the computing system comprising:

one or more communication devices; one or more memory or storage devices configured to store processor-executable instructions; and one or more processors operatively connected to the one or more memory or storage devices and the one or more communication devices, the one or more processors configured to execute the stored processor-executable instructions, wherein executing the stored processor-executable instructions causes the one or more processors to:

receive, from the accelerometer via the one or more communication devices, first acceleration data indicative of a first acceleration vector of the tap timer;

receive periodically, from the accelerometer via the one or more communication devices, second acceleration data indicative of a second acceleration vector of the tap timer after receiving the first acceleration data;

calculate a value based on the first acceleration data and the second acceleration data; and compare the value with a predetermined value threshold to determine whether the tap timer has detached from the faucet.

Executing the stored processor-executable instructions may further cause the one or more processors to:

transmit a notification signal, by the one or more communication devices, to a client device in response to the determination that the tap timer has detached from the faucet.

The value calculated may be a vector distance between the first acceleration vector and the second acceleration vector.

The predetermined value threshold may be about 0.68 m/s².

The value calculated may be an inclination angle derived from the first acceleration vector and the second acceleration vector.

The predetermined value threshold may be between 10 to 30 degrees.

The one or more processors may receive periodically, from the accelerometer via the one or more communication devices, the second acceleration data every 15 seconds.

Executing the stored processor-executable instructions may further cause the one or more processors to:

prior to calculating the value, validate the second acceleration data based on a predetermined validation threshold.

Executing the stored processor-executable instructions may further cause the one or more processors to:

prior to calculating the value, filter the second acceleration data.

In yet a further aspect of the present disclosure, there is provided a method of detecting detachment of a tap timer from a faucet, the method comprising:

measuring a first inclination angle of the tap timer; measuring periodically a second inclination angle of the tap timer after measuring the first inclination angle;

calculating a value based on the first inclination angle and the second inclination angle; and comparing the value with a predetermined value threshold to determine whether the tap timer has detached from the faucet.

The method may further comprise transmitting a notification signal to a network device in response to the determination that the tap timer has detached from the faucet.

The value calculated may be the difference between the second inclination angle and the first acceleration inclination angle.

The predetermined value threshold may be between 10 to 30 degrees.

The second inclination angle may be measured periodically every 15 seconds.

The method may further comprise, prior to calculating the value, validating the second inclination angle based on a predetermined validation threshold.

The method may further comprise, prior to calculating the value, filtering the second inclination angle.

In yet a further aspect of the present disclosure, there is provided a tap timer, comprising:

an inclinometer; a memory or storage device configured to store processor-executable instructions;

and a processor operatively connected to the memory or storage device and the inclinometer, the processor configured to execute the stored processor-executable instructions, wherein executing the stored processor-executable instructions causes the processor to:

receive, from the inclinometer, first inclination data indicative of a first inclination angle of the tap timer;

receive periodically, from the inclinometer, second inclination data indicative of a second inclination angle of the tap timer after receiving the first inclination data;

calculate a value based on the first inclination data and the second inclination data; and compare the value with a predetermined value threshold to determine whether the tap timer has detached from the faucet.

The tap timer may further comprise a wireless communication device operatively connected to the processor, and executing the stored processor-executable instructions may further cause the processor to:

transmit a notification signal, by the wireless communication device, to a network device in response to the determination that the tap timer has detached from the faucet.

The value calculated may be the difference between the second inclination angle and the first inclination angle.

The predetermined value threshold may be between 10 to 30 degrees.

The processor may receive periodically, from the inclinometer, the second inclination data every 15 seconds.

Executing the stored processor-executable instructions may further cause the processor to:

prior to calculating the value, validate the second inclination data based on a predetermined validation threshold.

Executing the stored processor-executable instructions may further cause the processor to:

prior to calculating the value, filter the second inclination data.

In yet a further aspect of the present disclosure, there is provided a computing system for detecting detachment of a tap timer from a faucet, the tap timer having an inclinometer, the computing system comprising:

one or more communication devices; one or more memory or storage devices configured to store processor-executable instructions; and one or more processors operatively connected to the one or more memory or storage devices and the one or more communication devices, the one or more processors configured to execute the stored processor-executable instructions, wherein executing the stored processor-executable instructions causes the one or more processors to:

receive, from the inclinometer via the one or more communication devices, first inclination data indicative of a first inclination angle of the tap timer;

receive periodically, from the inclinometer via the one or more communication devices, second inclination data indicative of a second inclination angle of the tap timer after receiving the first inclination data;

calculate a value based on the first inclination data and the second inclination data; and compare the value with a predetermined value threshold to determine whether the tap timer has detached from the faucet.

Executing the stored processor-executable instructions may further cause the one or more processors to:

transmit a notification signal, by the one or more communication devices, to a client device in response to the determination that the tap timer has detached from the faucet.

The value calculated may be the difference between the second inclination angle and the first inclination angle.

The predetermined value threshold may be between 10 to 30 degrees.

The one or more processors may receive periodically, from the inclinometer via the one or more communication devices, the second inclination data every 15 seconds.

Executing the stored processor-executable instructions may further cause the one or more processors to:

prior to calculating the value, validate the second inclination data based on a predetermined validation threshold.

Executing the stored processor-executable instructions may further cause the one or more processors to:

prior to calculating the value, filter the second inclination data.

### BRIEF DESCRIPTION OF DRAWINGS

Embodiments of the present disclosure will now be described hereinafter, by way of examples only, with reference to the accompanying drawings, in which:

FIG. 1 is a schematic illustration of an embodiment of tap timer in communication with a client device via a network device and a server;

FIG. 2 is a flow diagram showing an embodiment of a method of detecting detachment of the tap timer of FIG. 1 from a faucet;

FIG. 3 is an illustration of a three-dimensional Cartesian coordinate system showing a vector distance calculated between a first acceleration vector of the tap timer of FIG. 1 when attached to a faucet, and a second acceleration vector of the tap timer of FIG. 1 when detached from the faucet;

FIG. 4 is an illustration of a three-dimensional Cartesian coordinate system showing an inclination angle derived from a first acceleration vector of the tap timer of FIG. 1 when attached to the faucet, and a second acceleration vector of the tap timer of FIG. 1 when detached from the faucet;

FIG. 5 is a schematic illustration of another embodiment of tap timer in communication with a client device via a network device and a server;

FIG. 6 is a flow diagram showing another embodiment of a method of detecting detachment of the tap timer of FIG. 3 from a faucet; and

FIG. 7 is a schematic illustration of the tap timer of FIG. 1 or FIG. 5 when attached to the faucet (FIG. 7(a)) and detached from the faucet (FIG. 7(b)).

### DESCRIPTION OF EMBODIMENTS

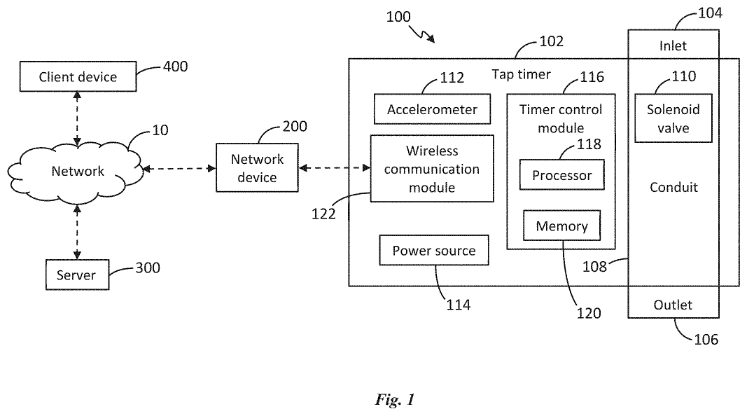

FIG. 1 shows an embodiment of a tap timer 100 in communication with a client device 300 via a network device 200 and a server 400. The tap timer 100 comprises a housing 102 which houses electronic components of the tap timer 100. The housing 102 has an inlet 104 configured to attach to a faucet, and an outlet 106 configured to attach to a conduit end of an irrigation sprinkler, for example. The tap timer 100 further comprises a conduit 108 in the housing 102 that extends between the inlet 104 and the outlet 106 for allowing fluid flow therethrough. A solenoid valve or motor 110 is disposed in the conduit 108 for controlling fluid flow through the conduit 108. The tap timer 100 also comprises a three-axis accelerometer 112 and a power source 114, e.g., a battery, for providing power to components of the tap timer 100.

In other embodiments, the tap timer 100 may comprise a plurality of outlets that are each configured to attach to a conduit end of an irrigation sprinkler. In this regard, the conduit may be configured to extend between the inlet and each of the outlets. The tap timer 100 may also comprise a plurality of solenoid valves corresponding to respective outlets.

Further, the tap timer 100 comprises a timer control module 116 operatively connected to the accelerometer 112 and the solenoid valve 110. In this embodiment, the timer control module 116 is in the form of a microcontroller having a processor 118 and a memory or storage device 120. The memory 120 is configured to store information and/or instructions for directing the processor 118 in accordance with the present embodiments, and may be read only memory (ROM), or a random access memory (RAM), or both, for example. The processor 118 is configured to execute instructions, such as those stored in the memory 120. The processor 118 is also configured to receive data from the accelerometer 112 and store the data in the memory 120.

Moreover, the tap timer 100 comprises a wireless communication module 122 in the form of a wireless transceiver operatively connected to the timer control module 116 for data transmission therebetween. The wireless communication module 122 is configured to communicate with a network device 200 through any wireless technology such as, for example, Wi-Fi, Zigbee, Z-Wave, Bluetooth, LoRa (Long Range), NB-IoT (Narrowband Internet of Things), or cellular network (e.g. 4G, 5G, etc.). The wireless communication module 122 is configured to route incoming/outgoing data signals to and from the tap timer 100 appropriately. For example, inbound data signals from the network device 200, such as watering commands, may be routed through the wireless communication module 122 before being directed to the processor 118, and outbound data signals from the processor 118 may be routed through the wireless communication module 122 before being transmitted externally to the network device 200.

In some embodiments, the electronic components and/or modules of the tap timer 100 may be mounted on a single PCB (Printed Circuit Board) or multiple interconnected PCBs.

The network device 200 is configured to communicate with a server 300 via a network 10. The network 10 may be any wireless network or any wired network, or a combination thereof. For example, the network 10 may include one or more of the following: the Internet, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, El or E3 line, a Digital Data Service (DDS) connection, a DSL (Digital Subscriber Line) connection, an Ethernet connection, an ISDN (Integrated Services Digital Network) line, a dial-up port such as a V.90, V.34, or V.34bis analog modem connection, a cable modem, an ATM (Asynchronous Transfer Mode) connection, a PSTN (public switched telephone network, or an FDDI (Fiber Distributed Data Interface) or CDDI (Copper Distributed Data Interface) connection.

The server 300 is configured to operatively couple with a client device 400 over the network 10 and to route data signals between the network device 200 and the client device 400 appropriately. In this embodiment, the client device 400 may be, for example, a smartphone, a portable computing device, a Personal Digital Assistance (PDA) or other devices of the like. The client device 400 can be connected with the server 300 by any form or medium of digital data communication appropriate to the client device 400. The client device 400 may be wirelessly connected to the server 300 over the network 10 (the Internet/cellular phone network). In some embodiments, the digital data communication may be a Local Area Network (LAN) or a Wide Area Network (WAN).

In other embodiments, the client device 400 may be embodied as one or more user devices. Each of the one or more user devices being communicatively connected to the server 300.

In some embodiments, the server 300 may be embodied as a server computer. In other embodiments, the server 300 may be embodied as one or more server computers networked together. The one or more server computers may be connected by any form or medium of digital data communication (e.g. LAN, WAN and/or the Internet).

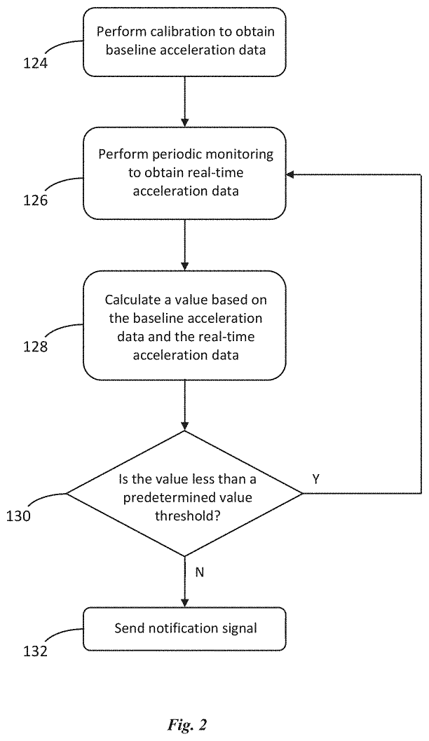

With reference to FIG. 2, the processor 118 of the timer control module 116 of the tap timer 100 is configured to execute instructions, such as those stored in the memory 120 to carry out the method operations described hereinbelow. The method operations are commenced only when the tap timer 100 is attached to the faucet, by the inlet 104, and in response to a user sending an activation signal from the client device 400 to the tap timer 100 via the network device 200 and the server 300. However, in other embodiments, the method operations may commence automatically after the tap timer 100 is attached to the faucet without any user input.

At step 124 of FIG. 2, the processor 118 first calibrates the tap timer 100 to obtain baseline acceleration data. Acceleration data measured by the accelerometer 112 is received by the processor 118 and recorded and stored in the memory 120. The acceleration data is received for each of the three different axes of the accelerometer 112. In this embodiment, six sets of acceleration data D1 (x, y, z), D2(x, y, z), D3(x, y, z), D4(x, y, z), D5(x, y, z), D6(x, y, z) are recorded for each of the X, Y and Z axes of the accelerometer 112, although any number of data sets are possible.

The processor 118 validates the acceleration data, received from the accelerometer 112, by calculating the mean value A.x, A.y, A.z of the acceleration data for each X, Y and Z axis of the accelerometer 112, as follows:

$$\begin{matrix}A . x = \frac{D 1. x + D 2. x + D 3. x + D 4. x + D 5. x + D 6. x}{6} & ( 1 ) \\ A . y = \frac{D 1. y + D 2. y + D 3. y + D 4. y + D 5. y + D 6. y}{6} & ( 2 ) \\ A . z = \frac{D 1. z + D 2. z + D 3. z + D 4. z + D 5. z + D 6. z}{6} & ( 3 )\end{matrix}$$

The processor 118 then calculates the standard deviation S(x), S(y), S(z) of the acceleration data for each X, Y and Z axis of the accelerometer 112 based on the mean value A.x, A.y, A.z, as follows:

$$\begin{matrix}S ( x ) = \sqrt[2]{\frac{{( D 1. x - A . x )}^{2} + {( D 2. x - A . x )}^{2} + … {( D 6. x - A . x )}^{2}}{6}} & ( 4 ) \\ S ( y ) = \sqrt[2]{\frac{{( D 1. y - A . y )}^{2} + {( D 2. y - A . y )}^{2} + … {( D 6. y - A . y )}^{2}}{6}} & ( 5 ) \\ S ( z ) = \sqrt[2]{\frac{{( D 1. z - A . z )}^{2} + {( D 2. z - A . z )}^{2} + … {( D 6. z - A . z )}^{2}}{6}} & ( 6 )\end{matrix}$$

Further, the processor 118 compares the calculated standard deviation S(x), S(y), S(z) with a predetermined validation threshold F(x), F(y), F(z) stored in the memory for each X, Y and Z axis. For example, in this embodiment, the predetermined validation thresholds F(x), F(y), F(z) for the X, Y and Z axes are F(x)=F(y)=F(z)=0.4. If the calculated standard deviation S(x), S(y), S(z) is greater than the predetermined validation threshold for any of the X, Y and Z axes, then calibration is repeated. If the calculated standard deviation S(x), S(y), S(z) is less than the predetermined validation threshold F(x), F(y), F(z) for each X, Y and Z axis, then the acceleration data is deemed valid.

Subsequently, the processor 118 filters the validated acceleration data by removing the minimum and maximum values of the set of validated acceleration data for each X, Y and Z axis of the accelerometer 112, and then calculating the mean value of the remaining values of the set of validated acceleration data for each X, Y and Z axis of the accelerometer 112. The mean value of the validated acceleration data for each X, Y and Z axis of the accelerometer 112 is stored in the memory 120 as baseline acceleration data. The baseline acceleration data is indicative of a first acceleration vector of the tap timer 100.

In other embodiments, calibration of the tap timer 100 may be carried out without the validating and filtering steps. In this regard, baseline acceleration data may be obtained directly from the recorded acceleration data.

After the baseline acceleration data is obtained, and as indicated at step 126 of FIG. 2, periodic monitoring of the tap timer 100 is performed to obtain real-time acceleration data. In this embodiment, periodic monitoring is performed every 15 seconds, although other sampling intervals are possible.

Acceleration data measured by the accelerometer 112 is received by the processor 118 and recorded and stored in the memory 120. The acceleration data is received for each of the three different axes X, Y, Z of the accelerometer 112. In this embodiment, six sets of acceleration data are recorded for each of the X, Y and Z axes of the accelerometer 112, although any number of data sets are possible.

The processor 118 validates the acceleration data by calculating the mean value A.x, A.y, A.z of the acceleration data for each X, Y and Z axis of the accelerometer 112, and subsequently the standard deviation S(x), S(y), S(z) based on the mean value A.x, A.y, A.z, in a similar manner to the calibration process described above. The processor 118 then compares the calculated standard deviation S(x), S(y), S(z) with the predetermined validation threshold (e.g. F(x)=F(y)=F(z)=0.4) stored in the memory 120. If the calculated standard deviation S(x), S(y), S(z) is greater than the predetermined validation threshold F(x), F(y), F(z), then real-time monitoring is repeated. If the calculated standard deviation S(x), S(y), S(z) is less than the predetermined validation threshold F(x), F(y), F(z), then the acceleration data is deemed valid. Subsequently, the processor 118 filters the validated acceleration data in a similar manner to the calibration process described above, by removing the minimum and maximum values of the set of validated acceleration data, and then calculating the mean value of the remaining values of the set of validated acceleration data. The mean value of the validated acceleration data is stored in the memory 120 as real-time acceleration data. The real-time acceleration data is indicative of a second acceleration vector of the tap timer 100.

In other embodiments, periodic monitoring of the tap timer 100 may be carried out without the validating and filtering steps. In this regard, real-time acceleration data may be obtained directly from the recorded acceleration data.

After the real-time acceleration data is obtained, a determination is made on whether the tap timer 100 has detached from the faucet based on the baseline acceleration data and the real-time acceleration data.

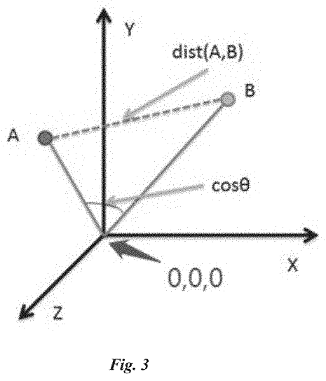

An example method of determining whether the tap timer 100 has detached from the faucet will now be described. At step 128 of FIG. 2, the processor 118 calculates a value based on the baseline acceleration data indicative of the first acceleration vector and the real-time acceleration data indicative of the second acceleration vector. In this embodiment, the value calculated is a vector distance dist(A, B) between the first acceleration vector A(x1, y1, z1) and the second acceleration vector B(x1, y1, z1). For example, with reference to FIG. 3, the processor 118 calculates the vector distance dist(A,B) as follows:

$$dist ( A , B ) = \sqrt[2]{{( x 2 - x 1 )}^{2} + {( y 2 - y 1 )}^{2} + {( z 2 - z 1 )}^{2}} \qquad ( 7 )$$

At step 130 of FIG. 2, the processor 118 compares the value with a predetermined value threshold set and stored in the memory 120 to determine whether the tap timer 100 has detached from the faucet. For example, in this embodiment, the predetermined value threshold for vector distance dist(A, B) is 0.68 m/s².

If, at step 130 of FIG. 2, the vector distance dist(A, B) is less than the predetermined value threshold, the tap timer 100 is deemed to still be attached to the faucet and periodic monitoring is repeated over a subsequent sampling time.

If, at step 130 of FIG. 2, the vector distance dist(A, B) is greater than the predetermined value threshold, the tap timer 100 is deemed to have detached from the faucet. In this regard, the processor 118 generates a notification signal with one or more alerts indicating that the tap timer 100 has detached from the faucet, and transmits the notification signal to the network device 200 via the wireless communication module 112 at step 132 of FIG. 2. Subsequently, the network device 200 sends the notification signal to the server 300 via the network 10, and the notification signal is then routed by the server 300 and delivered to the client device 400 via the network 10. In some embodiments, the server 300 may send the notification signal to the client device 400 as a push notification, email, automated voice call and/or short message service, for example. This allows a user to be notified of the detachment of the tap timer 100 from the faucet in a timely manner.

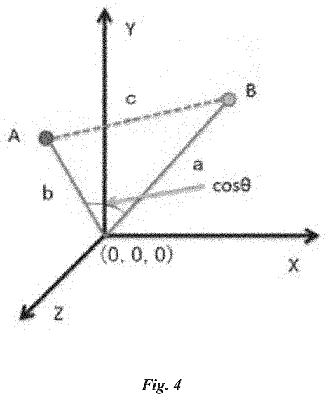

Another example method of determining whether the tap timer 100 has detached from the faucet will now be described. At step 128 of FIG. 2, the processor 118 calculates a value based on the baseline acceleration data indicative of the first acceleration vector and the real-time acceleration data indicative of the second acceleration vector. In this embodiment, the value calculated is an inclination angle θ derived from the first acceleration vector A(x1, y1, z1) and the second acceleration vector B(x1, y1, z1). For example, with reference to FIG. 4, the processor 118 calculates the inclination angle θ by calculating the vector distances a, b of the first acceleration vector A(x1, y1, z1) and the second acceleration vector B(x1, y1, z1) with respect to origin, as follows:

$$\begin{matrix}a = \sqrt[2]{{( x 1 - 0 )}^{2} + {( y 1 - 0 )}^{2} + {( z 1 - 0 )}^{2}} & ( 8 ) \\ b = \sqrt[2]{{( x 2 - 0 )}^{2} + {( y 2 - 0 )}^{2} + {( z 2 - 0 )}^{2}} & ( 9 )\end{matrix}$$

The processor 118 then calculates the vector distance c between the first acceleration vector A(x1, y1, z1) and the second acceleration vector B(x1, y1, z1), as follows:

$$c = d i s t ( A , B ) = \sqrt[2]{{( x 2 - x 1 )}^{2} + {( y 2 - y 1 )}^{2} + {( z 2 - z 1 )}^{2}} \qquad ( 10 )$$

Subsequently, the processor 118 calculates the inclination angle θ based on the vector distances a, b, c, as follows:

$$θ = arccos ( cos θ ) = arccos ( \frac{{b}^{2} + {c}^{2} - {a}^{2}}{2 bc} ) \qquad ( 11 )$$

At step 130 of FIG. 2, the processor 118 compares the value with a predetermined value threshold set and stored in the memory 120 to determine whether the tap timer 100 has detached from the faucet. For example, in this embodiment, the predetermined value threshold is between 10 to 30 degrees.

If, at step 130 of FIG. 2, the inclination angle θ is less than the predetermined value threshold, the tap timer 100 is deemed to still be attached to the faucet and periodic monitoring is repeated over a subsequent sampling time.

If, at step 130 of FIG. 2, the inclination angle θ is greater than the predetermined value threshold, the tap timer 100 is deemed to have detached from the faucet. In this regard, the processor 118 generates a notification signal with one or more alerts indicating that the tap timer 100 has detached from the faucet, and transmits the notification signal to the network device 200 via the wireless communication module 122 at step 132 of FIG. 2. Subsequently, the network device 200 sends the notification signal to the server 300 via the network 10, and the notification is then routed by the server 300 and delivered to the client device 400 via the network 10. In some embodiments, the server 300 may send the notification signal to the client device 400 as a push notification, email, automated voice call and/or short message service, for example. This allows a user to be notified of the detachment of the tap timer 100 from the faucet in a timely manner.

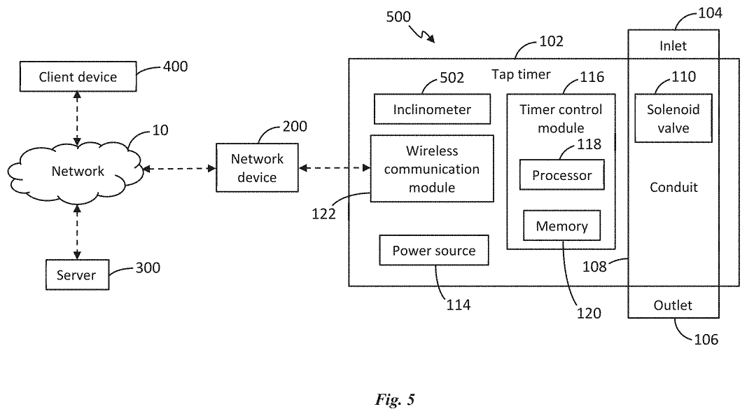

FIG. 5 shows another embodiment of a tap timer 500 similar to the tap timer 100 shown in FIG. 1 and like features have been indicated with like reference numerals. However, in this embodiment, the tap timer 500 has an inclinometer 502 in place of an accelerometer. The inclinometer 502 is operatively connected to the timer control module 116 and is configured to measure inclination data indicative of an inclination angle of the tap timer 500.

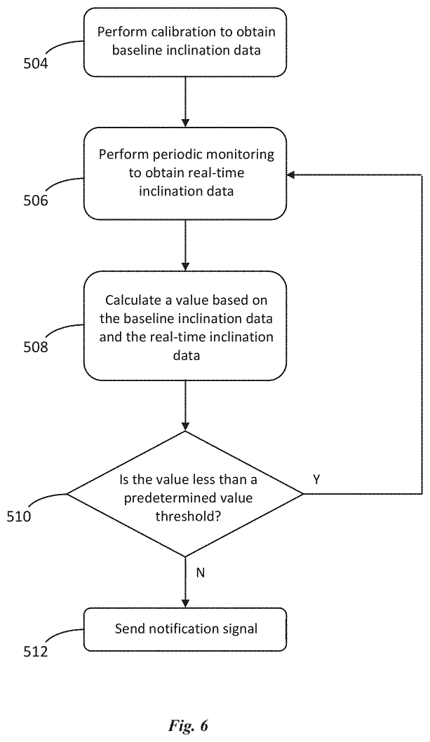

With reference to FIG. 6, the processor 118 of the timer control module 116 of the tap timer 500 is configured to execute instructions, such as those stored in the memory 120 to carry out the method operations described hereinbelow. The method operations are commenced only when the tap timer 500 is attached to the faucet, by the inlet 104, and in response to a user sending an activation signal from the client device 400 to the tap timer 500 via the network device 200 and the server 300. However, in other embodiments, the method operations may commence automatically after the tap timer 500 is attached to the faucet without any user input.

At step 504 of FIG. 6, the processor 118 first calibrates the tap timer 500 to obtain baseline inclination data. Inclination data measured by the inclinometer 502 is received by the processor 118 and recorded and stored in the memory 120 as baseline inclination data. The baseline inclination data is indicative of a first inclination angle of the tap timer 500.

After the baseline inclination data is obtained, and as indicated at step 506 of FIG. 6, periodic monitoring of the tap timer 500 is performed to obtain real-time inclination data. In this embodiment, periodic monitoring is performed every 15 seconds, although other sampling intervals are possible. Inclination data measured by the inclinometer 502 is received by the processor 118 and recorded and stored in the memory 120 as real-time inclination data. The real-time inclination data is indicative of a second inclination angle of the tap timer 500.

After the real-time inclination data is obtained, a determination is made on whether the tap timer 500 has detached from the faucet based on the baseline inclination data and the real-time inclination data. For example, at step 508 of FIG. 6, the processor 118 calculates a value based on the baseline inclination data indicative of the first inclination angle and the real-time inclination data indicative of the second inclination angle. In this embodiment, the value is the difference between the second inclination angle and the first inclination angle. At step 510 of FIG. 6, the processor 118 then compares the value with a predetermined value threshold set and stored in the memory 120 to determine whether the tap timer 500 has detached from the faucet. For example, in this embodiment, the predetermined value threshold is between 10 to 30 degrees.

If, at step 510 of FIG. 6, the value is less than the predetermined value threshold, the tap timer 500 is deemed to still be attached to the faucet and periodic monitoring is repeated over a subsequent sampling time.

If, at step 510 of FIG. 6, the value is greater than the predetermined value threshold, the tap timer 500 is deemed to have detached from the faucet. In this regard, the processor 118 generates a notification signal with one or more alerts indicating that the tap timer 500 has detached from the faucet, and transmits the notification signal to the network device 200 via the wireless communication module 122 at step 512 of FIG. 6. Subsequently, the network device 200 sends the notification signal to the server 300 via the network 10, and the notification signal is then routed by the server 300 and delivered to the client device 400 via the network 10. In some embodiments, the server 300 may send the notification signal to the client device 400 as a push notification, email, automated voice call and/or short message service, for example. This allows a user to be notified of the detachment of the tap timer 500 from the faucet in a timely manner.

Whilst in embodiments described above, the method operations are carried out by the onboard processor 118 of the tap timer 100, 500, in other embodiments, the method operations may be carried out by a computing system such as the network device 200, the server 300, or both. In this regard, it will be appreciated that the network device 200 and/or the server 300 may comprise one or more communication devices, one or more memory or storage devices configured to store processor-executable instructions, and one or more processors operatively connected to the one or more memory or storage devices and the one or more communication devices. It will also be appreciated that the acceleration data measured by the accelerometer 112 or the inclination data measured by the inclinometer 502 may be transmitted by the wireless communication module 122 to the network device 200 and/or the server 300 appropriately and recorded and stored in the one or more memory or storage devices of the network device 200 and/or the server 300.

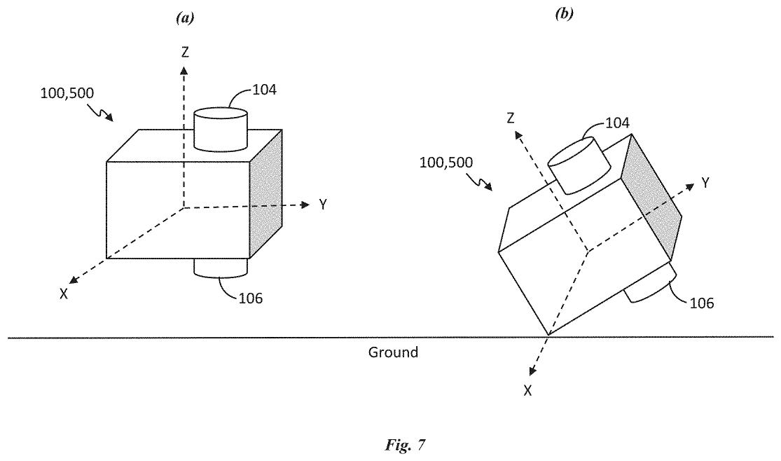

FIG. 7 shows an example of the relative orientations of the tap timer 100, 500 when attached to the faucet (FIG. 7(a)) and detached from the faucet (FIG. 7(b)), for example, when the tap timer 100, 500 is resting on the ground. This example shows that the detachment of the tap timer 100, 500 results in a change of the acceleration data of tap timer 100, measured by the accelerometer 112, and the inclination data of the tap timer 500, measured by the inclinometer 502. It will be appreciated that the detachment of the tap timer 100, 500 from the faucet can be detected through the implementation of embodiments of the present disclosure.

The embodiments described above have numerous advantages. For example, they detect the detachment of the tap timer 100, 500 from the faucet in a consistent and effective manner. The embodiments also allow users to be notified of the detachment of the tap timer in a timely manner through the transmission of the notification signal to the client device 400.

Further, performing periodic monitoring (e.g. every 15 seconds) means that the tap timer 100, 500 consumes power more efficiently.

In general, it will be recognised that any processor used in the computing system in the present disclosure may comprise a number of control or processing modules for controlling one or more features of the present disclosure and may also include one or more storage elements, for storing desired data. The modules and storage elements can be implemented using one or more processing devices and one or more data storage units, which modules and/or storage elements may be at one location or distributed across multiple locations and interconnected by one or more communication links. Processing devices may include computer systems such as desktop computers, laptop computers, tablets, smartphones, personal digital assistants and other types of devices, including devices manufactured specifically for the purpose of carrying out methods according to the present disclosure.

The features of the present embodiments described herein may be implemented in digital electronic circuitry, and/or in computer hardware, firmware, software, and/or in combinations thereof. Features of the present embodiments may be implemented in a computer program product tangibly embodied in an information carrier, such as a machine-readable storage device, and/or in a propagated signal, for execution by a programmable processor. Embodiments of the present method steps may be performed by a programmable processor executing a program of instructions to perform functions of the described implementations by operating on input data and generating output.

The features of the present embodiments described herein may be implemented in one or more computer programs that are executable on a programmable system including at least one programmable processor connected to receive data and/or instructions from, and to transmit data and/or instructions to, a data storage system, at least one input device, and at least one output device. A computer program may include a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, for example, both general and special purpose processors, and/or the sole processor or one of multiple processors of any kind of computer. Generally, a processor may receive instructions and/or data from a read only memory (ROM), or a random access memory (RAM), or both. Such a computer may include a processor for executing instructions and one or more memories for storing instructions and/or data.

Generally, a computer may also include, or be operatively connected to communicate with, one or more mass storage devices for storing data files. Such devices include magnetic disks, such as internal hard disks and/or removable disks, magneto-optical disks, and/or optical disks. Storage devices suitable for tangibly embodying computer program instructions and/or data may include all forms of non-volatile memory, including for example semiconductor memory devices, such as EPROM, EEPROM, and flash memory devices, magnetic disks such as internal hard disks and removable disks, magneto-optical disks, and CD-ROM and DVD-ROM disks. The processor and the memory may be supplemented by, or incorporated in, one or more Application-Specific Integrated Circuits (ASICs).

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method of detecting detachment of a tap timer from a faucet, the method comprising:
measuring a first acceleration vector of the tap timer;
measuring periodically a second acceleration vector of the tap timer after measuring the first acceleration vector;
calculating a value based on the first acceleration vector and the second acceleration vector; and
comparing the value with a predetermined value threshold to determine whether the tap timer has detached from the faucet.

2. The method according to claim 1, further comprising transmitting a notification signal to a network device in response to the determination that the tap timer has detached from the faucet.

3. The method according to claim 1, wherein the value calculated is a vector distance between the first acceleration vector and the second acceleration vector.

4. The method according to claim 3, wherein the predetermined value threshold is about 0.68 m/s².

5. The method according to claim 1, wherein the value calculated is an inclination angle derived from the first acceleration vector and the second acceleration vector.

6. The method according to claim 5, wherein the predetermined value threshold is between 10 to 30 degrees.

7. (canceled)

8. The method according to claim 1, further comprising, prior to calculating the value, validating the second acceleration vector based on a predetermined validation threshold.

9. (canceled)

10. A tap timer, comprising:
an accelerometer;
a memory or storage device configured to store processor-executable instructions; and
a processor operatively connected to the memory or storage device and the accelerometer, the processor configured to execute the stored processor-executable instructions, wherein executing the stored processor-executable instructions causes the processor to:
receive, from the accelerometer, first acceleration data indicative of a first acceleration vector of the tap timer;
receive periodically, from the accelerometer, second acceleration data indicative of a second acceleration vector of the tap timer after receiving the first vector data;
calculate a value based on the first acceleration data and the second acceleration data; and
compare the value with a predetermined value threshold to determine whether the tap timer has detached from the faucet.

11. The tap timer according to claim 10, further comprising a wireless communication device operatively connected to the processor, and wherein executing the stored processor-executable instructions further causes the processor to:
transmit a notification signal, by the wireless communication device, to a network device in response to the determination that the tap timer has detached from the faucet.

12. The tap timer according to claim 10, wherein the value calculated is a vector distance between the first acceleration vector and the second acceleration vector.

13. The tap timer according to claim 12, wherein the predetermined value threshold is about 0.68 m/s².

14. The tap timer according to claim 10, wherein the value calculated is an inclination angle derived from the first acceleration vector and the second acceleration vector.

15. The tap timer according to claim 14, wherein the predetermined value threshold is between 10 to 30 degrees.

16. (canceled)

17. The tap timer according to claim 10, wherein executing the stored processor-executable instructions further causes the processor to:
prior to calculating the value, validate the second acceleration data based on a predetermined validation threshold.

18-19. (canceled)

20. A computing system for detecting detachment of a tap timer from a faucet, the tap timer having an accelerometer, the computing system comprising:
one or more communication devices;
one or more memory or storage devices configured to store processor-executable instructions; and
one or more processors operatively connected to the one or more memory or storage devices and the one or more communication devices, the one or more processors configured to execute the stored processor-executable instructions, wherein executing the stored processor-executable instructions causes the one or more processors to:
receive, from the accelerometer via the one or more communication devices, first acceleration data indicative of a first acceleration vector of the tap timer;
receive periodically, from the accelerometer via the one or more communication devices, second acceleration data indicative of a second acceleration vector of the tap timer after receiving the first acceleration data;
calculate a value based on the first acceleration data and the second acceleration data; and
compare the value with a predetermined value threshold to determine whether the tap timer has detached from the faucet.

21. The computing system according to claim 20, wherein executing the stored processor-executable instructions further causes the one or more processors to:
transmit a notification signal, by the one or more communication devices, to a client device in response to the determination that the tap timer has detached from the faucet.

22. The computing system according to claim 20, wherein the value calculated is a vector distance between the first acceleration vector and the second acceleration vector.

23. The computing system according to claim 22, wherein the predetermined value threshold is about 0.68 m/s².

24. The computing system according to claim 20, wherein the value calculated is an inclination angle derived from the first acceleration vector and the second acceleration vector.

25. The computing system according to claim 24, wherein the predetermined value threshold is between 10 to 30 degrees.

26. (canceled)

27. The computing system according to claim 20, wherein executing the stored processor-executable instructions further causes the one or more processors to:
prior to calculating the value, validate the second acceleration data based on a predetermined validation threshold.

28-49. (canceled)
